(19) United States
(12) Patent Application Publication
(10) Pub. No.: US 2008/0285840 A1
(43) Pub. Date: Nov. 20, 2008

(54) Defect inspection apparatus performing defect inspection by image analysis

(75) Inventor: Akitoshi Kawai, Yokohama-city (JP)

Correspondence Address: OLIFF & BERRIDGE, PLC, P.O. BOX 320850, ALEXANDRIA, VA, 22320-4850, US

(73) Assignee: NIKON CORPORATION, TOKYO (JP)

(21) Appl. No.: 12/213,748

(22) Filed: Jun. 24, 2008

Related U.S. Application Data
(63) Continuation of application No. PCT/JP2006/325773, filed on Dec. 25, 2006.

(30) Foreign Application Priority Data
Dec. 26, 2005 (JP) 2005-372984

(51) Int. Cl. G06K 9/00

(52) U.S. Cl. 382/141

(57) ABSTRACT

A defect inspection apparatus obtains a color image signal of an inspection target. Based on a plurality of signal components forming this color image signal, a plurality of analysis images are obtained. Defect detection of an inspection target is implemented for each of the a plurality of analysis images. A differential is detected for a defect nomination detected for each of the analysis images, and thereby whether a plurality of defects exist or not in successive defect positions of the inspection target is determined.

### CROSS-REFERENCE TO RELATED APPLICATION

This application is a Continuation Application of International Application No. PCT/JP2006/325773, filed Dec. 25, 2006, designating the U.S., in which the International Application claims a priority date of Dec. 26, 2005, based on prior filed Japanese Patent Application No. 2005-372984, the entire contents of which are incorporated herein by reference.

### BACKGROUND

1. Field

The present application relates to a defect inspection apparatus performing defect inspection by image analysis.

2. Description of the Related Art

Conventionally, there is known a apparatus that performs defect detection by conducting data analysis on an image signal of an inspection target in microscopic inspection or the like of a semiconductor wafer or a liquid crystal substrate (refer to Patent Document 1: Japanese Unexamined Patent Application Publication No. 2003-302354).

Incidentally, depending on the inspection target, it is possible that plural defects occur in a same area in an overlapped manner. With the above-described conventional art, a defect position can be detected but it is difficult to determine whether plural defects overlap in the same area or not.

Further, depending on the inspection target, it is possible that a defect appears as a slight change of color. In the above-described conventional art, there is room for improvement in that it is difficult to detect this type of slight change of color with good sensitivity and hence the defect cannot be detected.

### SUMMARY

A proposition is to determine whether or not a plurality of defects occur in a defect position of an inspection target.

Further, another proposition is to provide a technique to detect a defect that appears as a slight change of color.

A defect inspection apparatus includes an illumination unit, an image capturing unit, and a defect detection unit.

The illumination unit illuminates an inspection target.

The image capturing unit obtains a color image signal of the inspection target.

The defect detection unit detects a defect of the inspection target based on the color image signal obtained by the image capturing unit.

Moreover, this defect detection unit includes a component extracting unit, a detection unit, and a determination unit.

The component extracting unit obtains a plurality of analysis images based on a plurality of signal components forming the color image signal.

The detection unit performs defect detection of the inspection target for each of the a plurality of analysis images, and detects a defect nomination for each of the analysis images.

The determination unit determines sameness of the defect nominations among the a plurality of analysis images to thereby determine whether a plurality of defects exist or not in a defect position of the inspection target.

In a defect inspection apparatus, the component extracting unit obtains at least two of the analysis images with at least two of the signal components being taken as pixel values, the signal components being selected from a group including the following six types of signal components.

three signal components forming the color image signal.

three signal components of hue/saturation/intensity obtained from the signal components.

In a defect inspection apparatus, the detection unit obtains a barycentric position, a vertical length, and a horizontal length of the defect nomination for each of the analysis images.

The determination unit determines that one defect exists in the defect position of the inspection target when all of the barycentric position, the vertical length, and the horizontal length for the defect nomination for each of the analysis images are evaluated to be equal.

On the other hand, the determination unit determines that a plurality of defects exist in the defect position of the inspection target when any one of the barycentric position, the vertical length, and the horizontal length is evaluated to be different.

In a defect inspection apparatus, the detection unit detects the defect nomination based on a differential between an analysis image of a predetermined reference image and an analysis image of the inspection target.

In a defect inspection apparatus, the detection unit performs level correction on the analysis image of the inspection target in an entirety thereof so that a differential between entire images of the analysis image of the reference image and the analysis image of the inspection target becomes small.

In a defect inspection apparatus, the detection unit has threshold values set in advance respectively for the a plurality of analysis images. The detection unit detects the defect nomination by determining with the threshold values a differential between the analysis image of the reference image and the analysis image of the inspection target.

In another defect inspection apparatus includes an illumination unit, an image capturing unit, and a defect detection unit.

The illumination unit illuminates an inspection target having a film on a surface.

The image capturing unit obtains a color image signal of the inspection target.

The defect detection unit detects a defect of the inspection target based on the color image signal obtained by the image capturing unit.

Moreover, the defect detection unit includes a component extracting unit and a detection unit.

The component extracting unit obtains a color information image having a pixel value corresponding to the color information based on at least one of saturation and hue of the color image signal.

The detection unit performs defect detection of the inspection target based on the color information image, and detects a defect nomination on thickness of the film.

The defect inspection apparatus according to any one of the above-described units includes a microscope optical system and an imaging unit.

The microscope optical system forms an enlarged image of the inspection target.

The imaging unit images the enlarged image and generates a color image signal.

The aforementioned image capturing unit obtains the color image signal generated by the imaging unit.

A defect inspection apparatus detects a defect nomination for each analysis image.

The defect inspection apparatus compares defect nominations among these plural analysis images to thereby determine whether a plurality of defects occurred or not in a defect position of the inspection target.

Further, another defect inspection apparatus detects a defect nomination from a saturation image. Therefore, a defect that appears as a slight change of color can be detected as a saturation change.

### BRIEF DESCRIPTION OF THE DRAWINGS

FIG. 1 is an explanatory diagram illustrating an embodiment.

FIG. 2 is a flowchart explaining an operation of the embodiment.

FIG. 3 is a table showing an example of color space selection guidance for respective defects stored in an inspection condition file 16.

FIG. 4 is an image showing comparison of taken images.

FIG. 5 are images showing comparison of RGB images.

FIG. 6 are charts showing signal waveforms of RGB images.

FIG. 7 are images showing comparison of HSI (hue/saturation/intensity) images.

FIG. 8 are charts showing signal waveforms of HSI (hue/saturation/intensity) images.

FIG. 9 is an image showing comparison of taken images.

FIG. 10 are images showing comparison of RGB images.

FIG. 11 are charts showing signal waveforms of RGB images.

FIG. 12 are images showing comparison of HSI (hue/saturation/intensity) images.

FIG. 13 are charts showing signal waveforms of HSI (hue/saturation/intensity) images.

FIG. 14 is an exterior view of a microscope 100. and

FIG. 15 is a chart showing a relationship between pattern line widths and saturation changes.

### DETAILED DESCRIPTION OF THE EMBODIMENTS

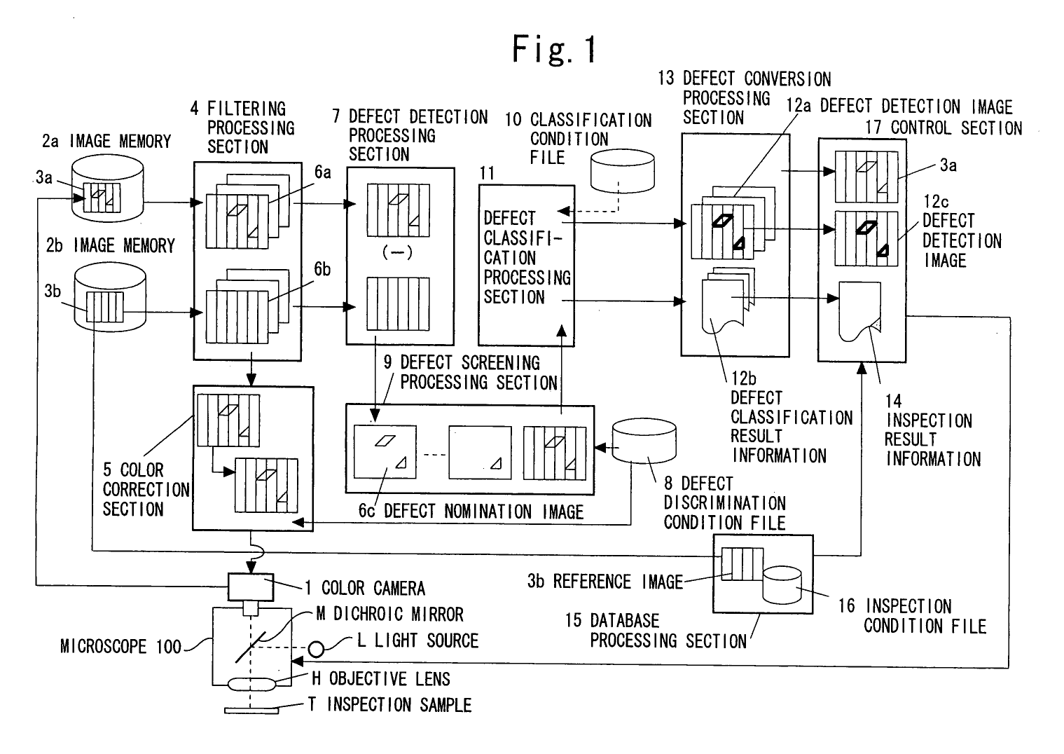

FIG. 1 is an explanatory diagram illustrating one embodiment.

A color camera 1 is coupled to a microscope 100 by an adapter. A light source L of this microscope 100 illuminates an inspection target T via a dichroic mirror M and an objective lens (microscope optical system) H. Reflected light of the inspection target T forms an enlarged image of the inspection target T via the objective lens H and the dichroic mirror M.

A control section 17 obtains an inspection condition file 16 from a database processing section 15. Based on a program in this inspection condition file 16, the control section 17 implements control of carrying the inspection target T, position control for a imaged position of the inspection target T, or the like.

The color camera 1 images the enlarged image of the inspection target T in response to an instruction from the control section 17 and generates an inspection image 3a.

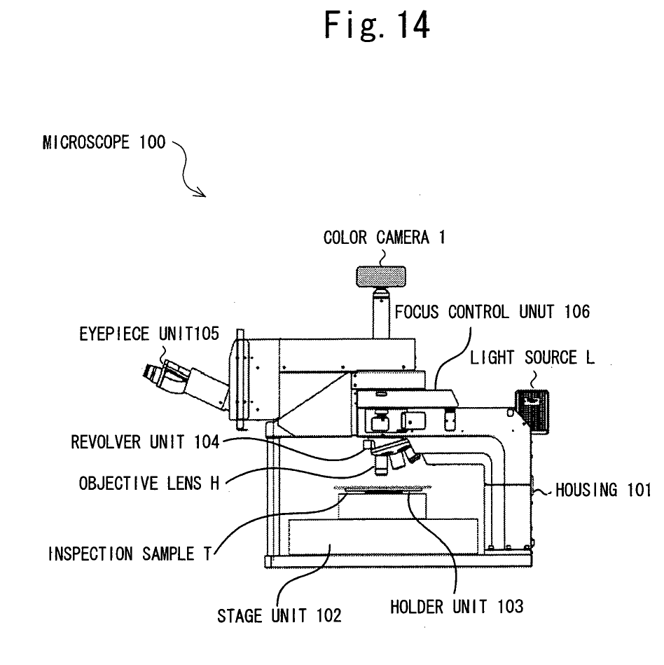

FIG. 14 is an exterior view of this microscope 100. A housing 101 of the microscope 100 is provided with a stage unit 102 that is position-controlled with a motor. On this stage unit 102, a holder unit 103 is provided, on which an inspection sample T is placed. Above the inspection sample T, the objective lens H is provided, which is fixed to a revolver unit 104 that is driven rotary. The illumination light of the light source L illuminates the inspection sample T through the objective lens H. The light coming back from the inspection sample T is made incident on the objective lens H and thereafter led to an eyepiece unit 105 and the color camera 1. On this light path, a focus control unit 106 is provided. This focus control unit 106 implements focus control by controlling the position of the optical system (or the inspection target T) in an optical axis direction. In addition, besides this microscope 100, the microscope system is provided with a carrying apparatus for the inspection sample T, a computer for control and image processing, and so on.

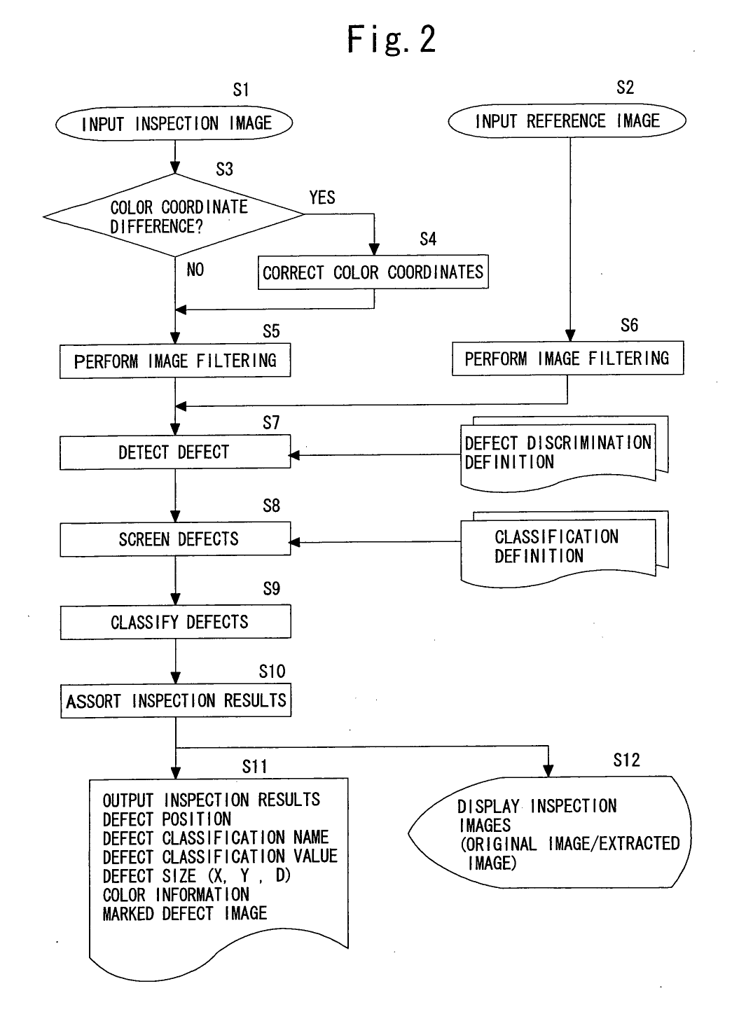

FIG. 2 is a chart illustrating a procedure of signal processing of this inspection image 3a.

Hereinafter, an overall flow of the signal processing will be explained with reference to FIG. 1 and FIG. 2.

Operation S1: the color camera 1 outputs a color image signal made up of RGB. An image memory 2a stores the inspection image 3a ((for example, a color image signal of a silicon wafer as an inspection target) output from the color camera 1.

Operation S2: a reference image 3b to be a reference is input to an image memory 2b.

As this reference image 3b, for example, an image may be generated by photographing in advance a target object (e.g. a good product) of the same type as the inspection target. Further, for example, when the inspection target has a cyclic pattern like a silicon wafer, the adjacent pattern of the inspection image 3a may be photographed to be the reference image 3b. Such an obtaining procedure of the reference image may be programmed in the inspection condition file 16 in advance.

Operation S3: a color correction section 5 detects a difference (color coordinate difference, intensity difference) of the entire image for the inspection image 3a and the reference image 3b. When both the color coordinate difference and the intensity difference are within a tolerance range, the color correction section 5 advances the operation to operation S5. On the other hand, when either of the color coordinate difference and the intensity difference is out of the tolerance range, the color correction section 5 advances the operation to operation S4.

Operation S4: when the intensity difference is out of the tolerance range, the color correction section 5 corrects the brightness of the light source L and images the inspection target T again.

Further, when the color coordinate difference is out of the tolerance range, the color correction section 5 performs color correction (color coordinate conversion or the like) on the inspection image 3a so as to cancel the color coordinate difference.

Operation S5: a filtering processing section 4 processes signal components (such as RGB) of the inspection image 3a, and generates at least two types of analysis images 6a.

Operation S6: the filtering processing section 4 processes signal components (such as RGB) of the reference image 3b similarly to the operation S5, and generates at least two types of analysis images 6b corresponding to the analysis images 6a.

Operation S7: a defect detection processing section 7 determines a local differential of the analysis images 6a, 6b by threshold conditions set in a defect discrimination condition file 8, and screens defect nominations. Defect nomination images 6c are images of screened defect nominations.

Operation S8: a defect screening processing section 9 detects shape patterns and barycentric positions for defect nominations of these plural defect nomination images 6c. The detected shape patterns and barycentric positions of the defect nomination images 6c are compared with each other. When all of them are identical, it is determined that there is a same defect, and when any one of them is different, it is determined that there are different defects. Further, the defect screening processing section 9 generates a defect detection image 12a based on the determination result.

Operation S9: a defect classification processing section 11 determines a defect factor of a defect shown on the defect detection image 12a by making an inquiry about the type of the defect detection image 12a to a classification condition file 10, and outputs the defect factor as defect classification result information 12b. Further, the defect classification processing section 11 sends the defect detection image 12a to a defect conversion processing section 13.

Operation S10: the defect conversion processing section 13 image-synthesizes the defect detection image 12a generated for each type of analysis images, and generates a defect detection image 12c indicating plural types of defects on one image. Further, the defect conversion processing section 13 adds a line pattern indicating contour information of a defect to the defect detection image 12a according to the shape pattern of the defect. Furthermore, the defect conversion processing section 13 may perform marking of color, symbol, link information, or the like indicating the defect factor at the position of each defect.

Operation S11: moreover, the defect conversion processing section 13 performs data integration for the defect classification result information 12b generated for each type of analysis images, to thereby generate inspection result information 14. In this inspection result information 14, a data list is stored which includes, for example, defect position (position of the inspection target T by coordinates or die coordinates for example), defect size (X-Y-Diameter), detected color component, defect factor, and so on.

Operation S12: the control section 17 displays the defect detection image 12c on an external monitor screen. On the monitor screen, the defect image on which the above-described marking is performed is displayed.

Hereinafter, characteristic operations of respective sections of this embodiment will be explained.

[Generation of Analysis Image]

Next, an operation of generating the above-described analysis images will be explained.

The filtering processing section 4 first generates the following three types of analysis images based on the signal components of the inspection image 3a.

R image . . . analysis image having pixel values which are signal components of R (red) of the inspection image 3a.

G image . . . analysis image having pixel values which are signal components of G (green) of the inspection image 3a.

B image . . . analysis image having pixel values which are signal components of B (blue) of the inspection image 3a.

Next, the filtering processing section 4 implements calculation of the following expressions for example based on the signal components of RGB, and extracts signal components of H (hue), S (saturation), I (intensity).

$$\begin{matrix}[ Mathematical expression 1 ] & \\ H = {cos}^{- 1} [ \frac{\frac{1}{2} [ ( R - G ) + ( R - B ) ]}{\sqrt{{( R - G )}^{2} + ( R - B ) ( G - B )}} ] & [ 1 ] \\ S = 1 - \frac{3}{R + G + B} [ min ( R , G , B ) ] & [ 2 ] \\ I = \frac{1}{3} ( R + G + B ) & [ 3 ]\end{matrix}$$

Based on these signal components, the following three types of analysis images are further generated.

H image . . . analysis image having pixel values which are signal components of H (hue) of the inspection image 3a.

S image . . . analysis image having pixel values which are signal components of S (saturation) of the inspection image 3a.

I image . . . analysis image having pixel values which are signal components of I (intensity) of the inspection image 3a.

The filtering processing section 4 generates the above-described six types of analysis images also for signal components of the reference image 13b.

[Relationship Between Defect Factor and Analysis Image]

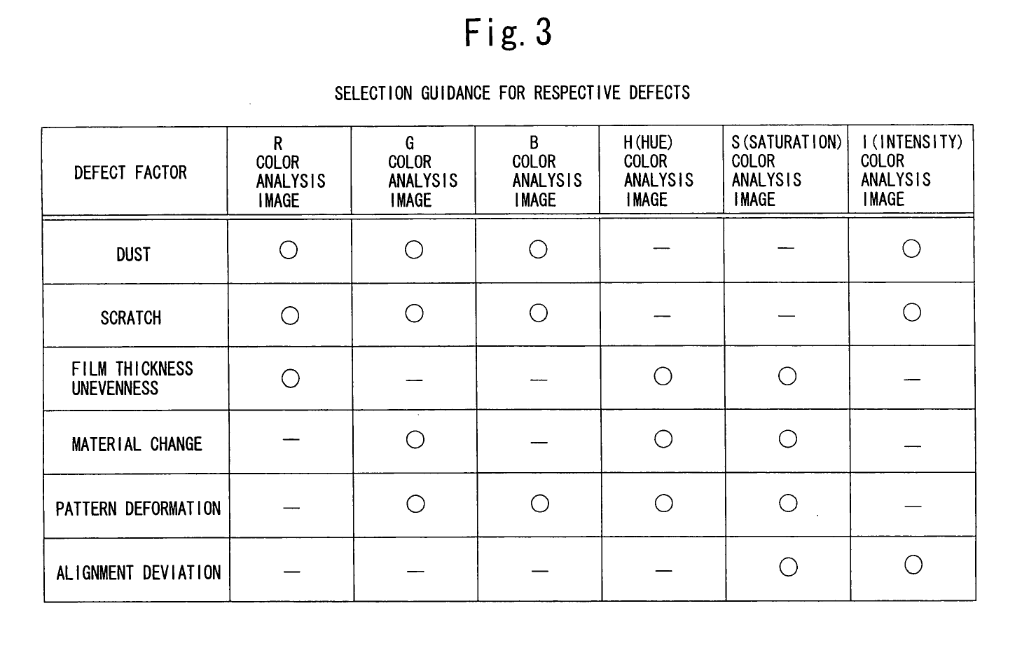

FIG. 3 is a table showing which analysis image should be selected for respective defect factors. A symbol “O” in FIG. 3 denotes an analysis image that should be selected. A symbol “-” in FIG. 3 denotes an analysis image that is not particularly needed to be selected.

For example, dust adhering on the inspection target generates a local change of brightness/darkness on the inspection image 3a. Accordingly, a defect of dust can be detected by determining a local differential generated in the R image, G image, B image, and I image.

Further, for example, a scratch on a surface of the inspection target also generates a local change of brightness/darkness on the inspection image 3a. Accordingly, a defect of scratch can be detected by determining a local differential generated in the R image, G image, B image, and I image.

In addition, for dust and scratch, the value of the locally generated change of brightness/darkness and the contour shape of the location thereof are different. Accordingly, dust and scratch can be discriminated based on the value of the local change of brightness/darkness and the contour shape of the location of the change of brightness/darkness.

Further, for example, a film thickness unevenness of the inspection target changes a state of interference of reflected light, and hence generates a change of wavelength. Accordingly, a significant change can easily occur in the H image (hue) and the S image (saturation) of the inspection image 3a. Further, the effect of the change of wavelength of the reflected light can easily occur significantly in the R image (long wavelength region). Therefore, a defect of this film thickness unevenness can be discriminated by determining a local differential generated in the R image, H image, and S image.

Further, for example, a foreign object (material change of a surface) of the inspection target can generate a change of spectral characteristics of the reflected light. This change of spectral characteristics occurs significantly in the H image (hue) and the S image (saturation) of the inspection image 3a. Further, this change of spectral characteristics can easily occur significantly in the G image (intermediate wavelength region) as well. Accordingly, a defect of this material change can be discriminated by determining a local differential generated in the G image, H image, and S image.

Further, for example, a pattern deformation of the inspection target can generate disturbance in diffusion characteristics of the reflected light. This disturbance in diffusion characteristics occurs significantly in the H image (hue) and the S image (saturation) of the inspection image 3a. Further, this disturbance in diffusion characteristics occurs significantly in the G image (intermediate wavelength region) and the B image (short wavelength region) as well. Accordingly, a defect of this pattern deformation can be discriminated by determining a local differential generated in the H image, S image, G image, and B image.

Further, for example, an alignment deviation of the inspection target appears as a change of saturation and a change of intensity of the reflected light. Accordingly, a defect of this alignment deviation can be discriminated by determining a local differential occurring in the S image and the I image.

As above, according to the selection guidance shown in FIG. 3, the filtering processing section 4 can generate an appropriate analysis image depending on a defect factor to be detected.

[Features of Operation of the Color Correction Section 5]

Between the inspection image 3a and the reference image 3b, a differential occurs also by a difference in photographing conditions or illumination conditions of the color camera 1. Accordingly, this type of differential has to be distinguished from a differential by a defect factor for determining a defect nomination.

Here, the difference in photographing condition or illumination condition appears as an overall differential of the inspection image 3a. On the other hand, a defect nomination appears as a partial differential of the inspection image 3a. Focusing attention on this point, the color correction section 5 obtains the absolute value of a difference in signal components between the inspection image 3a and the reference image 3b, and adds this absolute value to the entire image.

The color correction section 5 performs color correction on the inspection image 3a so that the color coordinate difference indicated by this additional value becomes minimum.

Further, the color correction section 5 performs level correction (gradation correction) on the inspection image 3a so that the intensity difference indicated by this additional value becomes minimum.

Moreover, when the intensity difference indicated by the additional value is larger than a threshold value set in the defect discrimination condition file 8, it can be determined that the photographing condition and the illumination condition need to be changed. In this case, the color correction section 5 obtains an intensity difference between the inspection image 3a and the reference image 3b. The color correction section 5 adjusts the brightness of the light source L or the exposure time of the color camera 1 so as to cancel this intensity difference. In this state, the color camera 1 photographs the inspection target T again, and generates a new inspection image 3a. In addition, when adjusting the brightness of the light source L, it is preferable that the H component and the S component are excluded from the threshold determination of an additional value.

Further, when the additional value is larger than the threshold value in the defect discrimination condition file 8 even after repeating the photographing for a predetermined number of times, it is preferable to exclude the inspection target T from inspection targets. In addition, the excluded inspection target T is saved as an exclusion record in the inspection result information 14.

[Features of Operation of the Defect Detection Processing Section 7]

In the defect discrimination condition file 8, for each type of analysis images 6a, 6b generated by the filtering processing section 4, threshold values for performing defect discrimination on a differential between the analysis images 6a, 6b are stored. This defect discrimination condition file 8 is preferred to be determined by way of experiment for each inspection target.

The defect detection processing section 7 compares the analysis images 6a, 6b in units of pixels, and detects a local differential. The defect screening processing section 9 determines the local differential based on the threshold values in the defect discrimination condition file 8 and screens defect nominations.

[Features of Operation of the Defect Screening Processing Section 9]

The defect screening processing section 9 performs image analysis for each defect nomination image 6c, and obtains a pattern shape and a barycentric position of a defect nomination. For example, the defect screening processing section 9 obtains the length in a vertical direction, the length in a horizontal direction, and a barycentric position for an image area in which there are successive pixel values (1 for a binary image for example) indicating a defect nomination for each defect nomination image 6c of the signal components R, G, B, H, S, I.

Further, the defect screening processing section 9 compares pattern shapes and barycentric positions of these defect nominations among different analysis images (R, G, B, H, S, I, and so on). At this time, when all the pattern shapes and barycentric positions match among different analysis images, the defect screening processing section 9 determines that one defect factor exists at a defect position of the inspection target. On the other hand, when any one of the pattern shapes and the barycentric positions is evaluated to be different among different analysis images, the defect screening processing section 9 determines that plural defect factors exist at a defect position of the inspection target.

With such processing, the defect screening processing section 9 can identify a position where a single defect nomination exists and a position where plural defect nominations exist in an overlapped manner.

In addition, to what extent a difference in pattern shapes and a difference in barycentric position should be considered as matching is preferably determined by an error tolerance value that is set in advance in the defect discrimination condition file 8.

### EXAMPLE

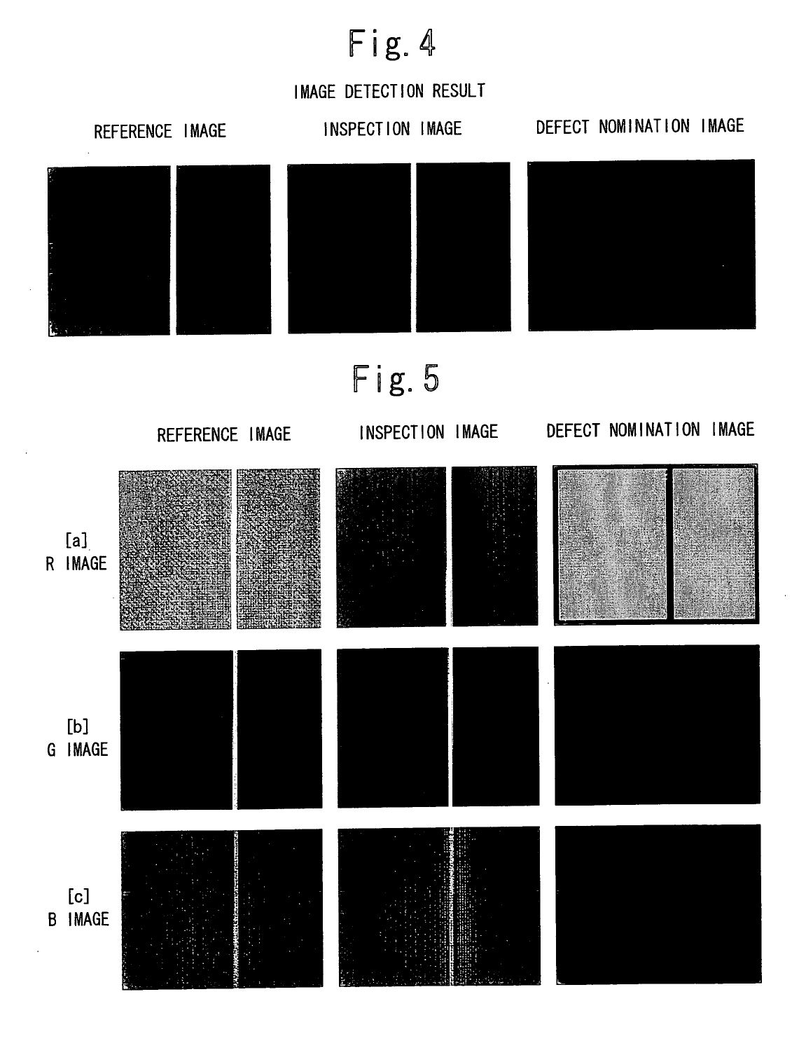

Example of this embodiment will be explained using FIG. 4 to FIG. 13.

Example illustrates an example of detecting an area of a film thickness defect or a film thickness unevenness as a defect pixel when a resist film is provided on a silicon wafer as the inspection target T. The film thickness defect means that the film thickness is too thick or too thin. The film thickness unevenness means that the film thickness is not uniform and has unevenness.

FIG. 4 illustrates a result of comparing an inspection image (3a) taken by the color camera 1 and a reference image (3b) as they are. As is clear from FIG. 4, no defect can be found in the comparison result (defect nomination image). This is because no differential occurred at a defect portion of the inspection image in this case.

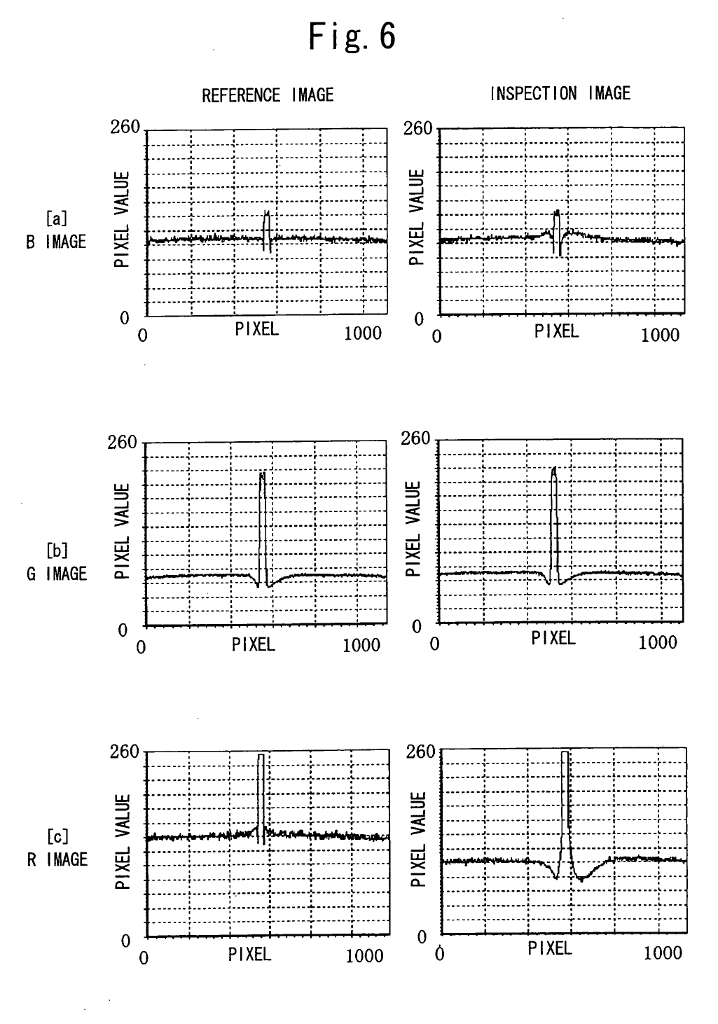

FIGS. 5[a] to 5[c] show R image/G image/B image generated by separately extracting signal components RGB of this inspection image (3a). In the defect nomination images shown in FIGS. 5[a] to 5[c], an area of gray to white is an area in which a differential occurred (range of defect nomination). On the other hand, a dark area in the defect nomination images indicates an area where no differential occurred. FIGS. 6[a] to 6[c] illustrate signal waveforms of these R image/G image/B image.

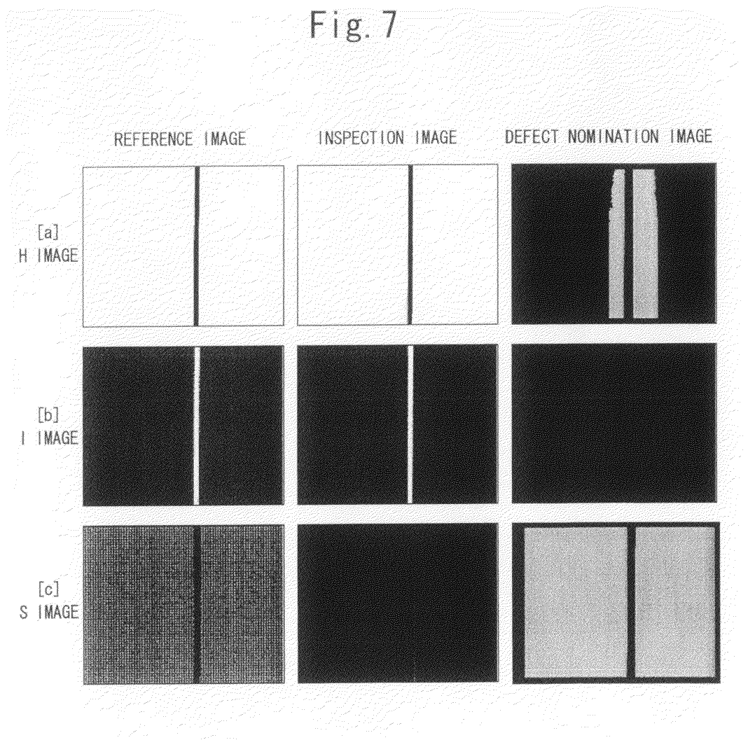

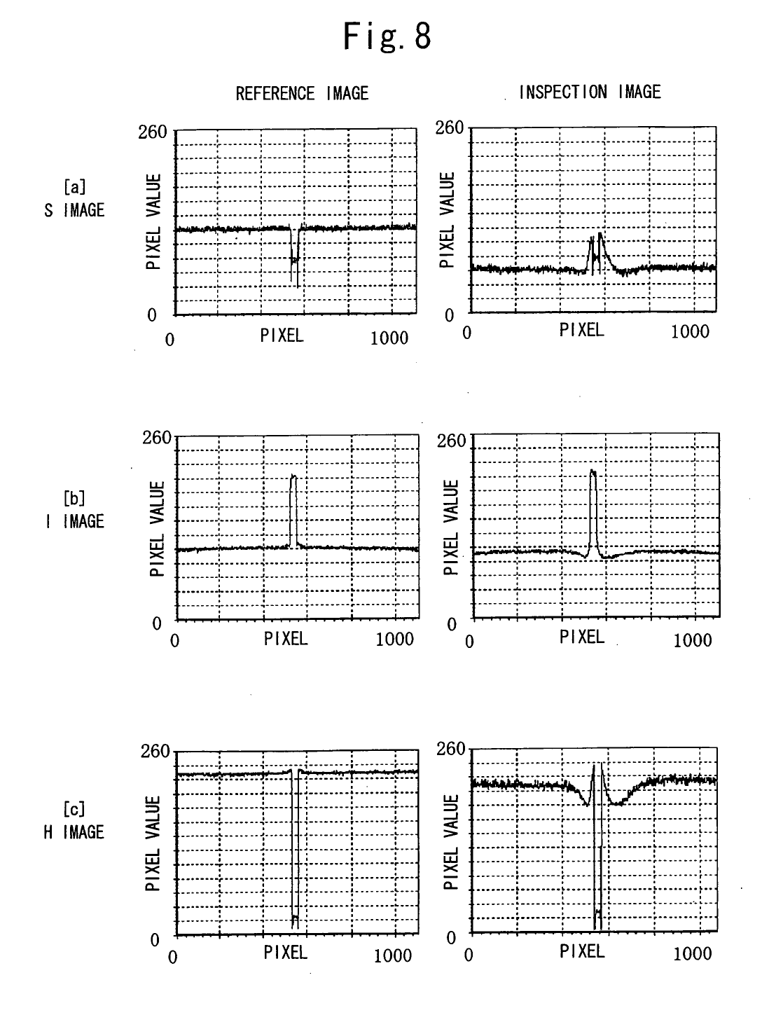

FIGS. 7[a] to 7[c] are H image/I image/S image generated by substituting the signal components RGB of the inspection image in the above-described expressions [1] to [3]. In the defect nomination images shown in FIGS. 7[a] to 7[c], an area of gray to white is an area in which a differential occurred (range of defect nomination). On the other hand, a dark area in the defect nomination images indicates an area where no differential occurred. FIGS. 8[a] to 8[c] illustrate signal waveforms of these S image/I image/H image.

A change of film thickness of the inspection target T causes a change of interference state to occur in the reflected light, and causes a change of hue (H) and saturation (S) to occur in the inspection image. Further, reflection characteristics of a long wavelength region also change, and hence a change of red (R) occurs in the inspection image. Accordingly, as shown in FIG. 5 to FIG. 8, a defect of film thickness can be detected in the H image/S image/R image.

A particularly important point is that, as shown in FIG. 8[c], a local film thickness unevenness appears significantly, which occurs in the vicinity of a wiring pattern (vertical line in the inspection image) in the H image of the inspection image. Strictly speaking, also in the S image of the inspection image, a local film thickness unevenness appears in the vicinity of a wiring pattern as shown in FIG. 8[a]. However, in the S image, this local film thickness unevenness cannot be simply distinguished because it is hidden in a change of saturation of the film thickness unevenness that occurs in a wide area.

In this embodiment, in defect nomination images of R image/S image/H image, barycentric positions, vertical lengths, and horizontal lengths of defect nominations are obtained. These features of the defect nominations are compared among the R image/S image/H image.

Consequently, all the features of defect nominations match in the R image and the S image. In this case, acommon wide-area defect nomination (film thickness unevenness) can be determined as one defect.

On the other hand, in the H image, as compared to the R image and the S image, one or more features of the defect nominations are different. Therefore, a defect nomination (film thickness unevenness) occurred locally in the H image can be determined as a defect different from the wide-area film thickness unevenness.

### EXAMPLE

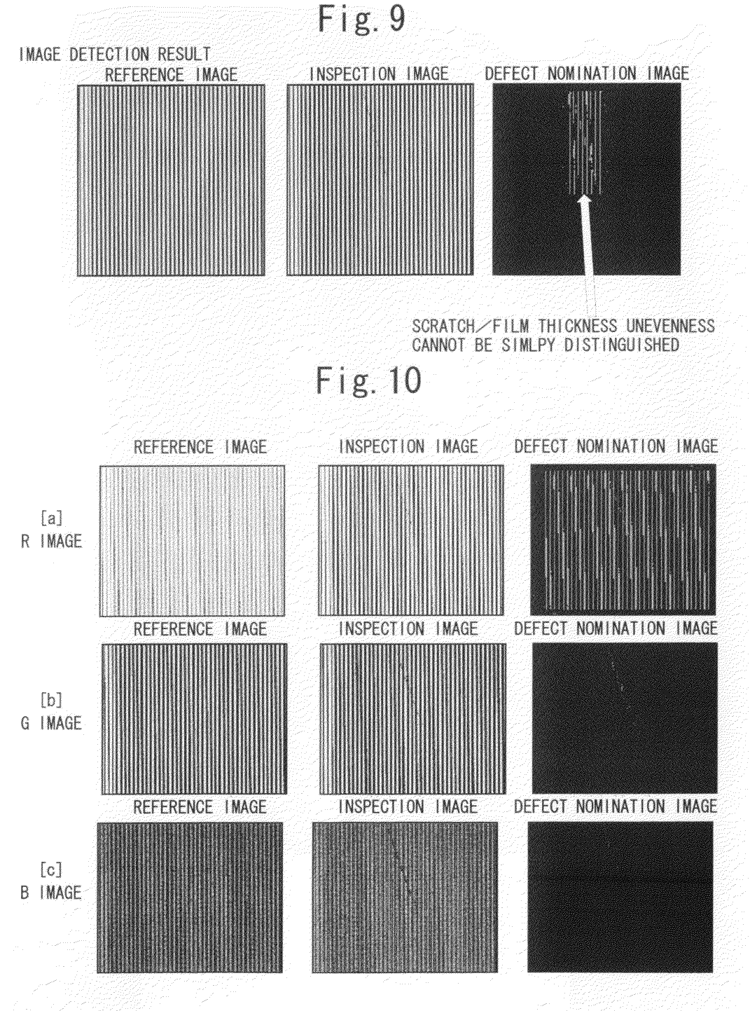

That is another example of this embodiment will be explained using FIG. 9 to FIG. 13.

The example is an example where the inspection target T is a silicon wafer, wiring patterns are provided on the silicon wafer, and an oxide film is provided between the wiring patterns. Here, a scratch on a wiring pattern and a defect of film thickness are detected as defects.

FIG. 9 illustrates a result of comparing an inspection image (3a) taken by the color camera 1 and a reference image (3b) as they are. As is clear from FIG. 9, a defect nomination is detected in the comparison result (defect nomination image). However, in this case, a scratch on a pattern and a film thickness defect cannot be distinguished.

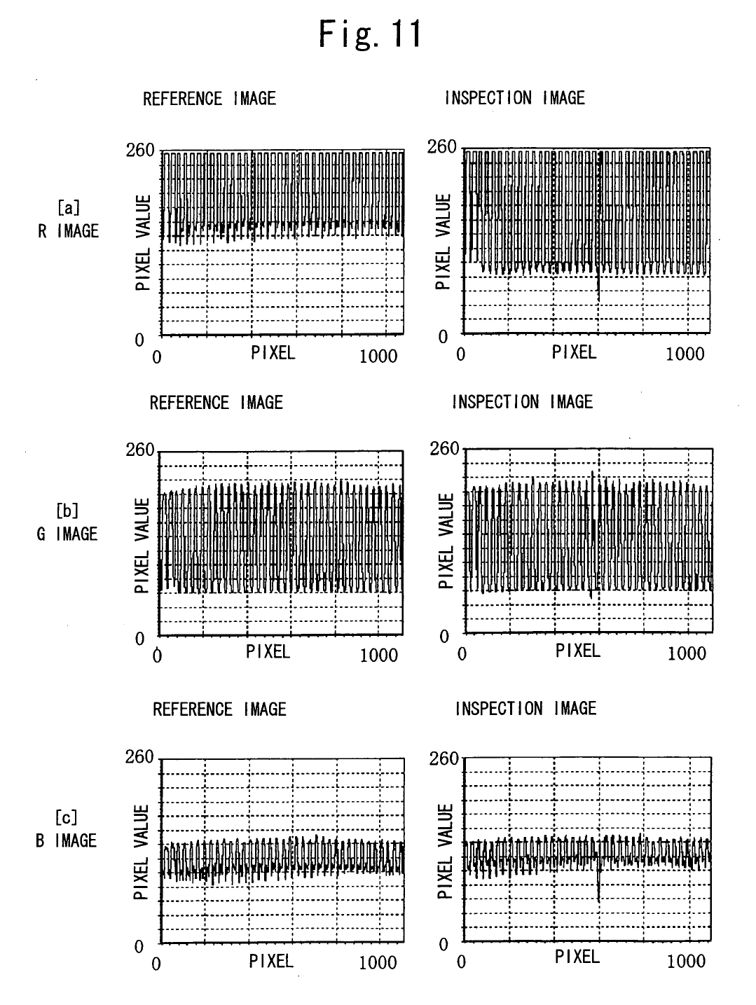

FIGS. 10[a] to 10[c] show R image/G image/B image generated by separately extracting signal components RGB of this inspection image (3a). In the defect nomination images shown in FIGS. 10[a] to 10[c], an area of gray to white is an area in which a differential occurred (range of defect nomination). On the other hand, a dark area in the defect nomination images indicates an area where no differential occurred. FIGS. 11 [a] to 11 [c] illustrate signal waveforms of these R image/G image/B image.

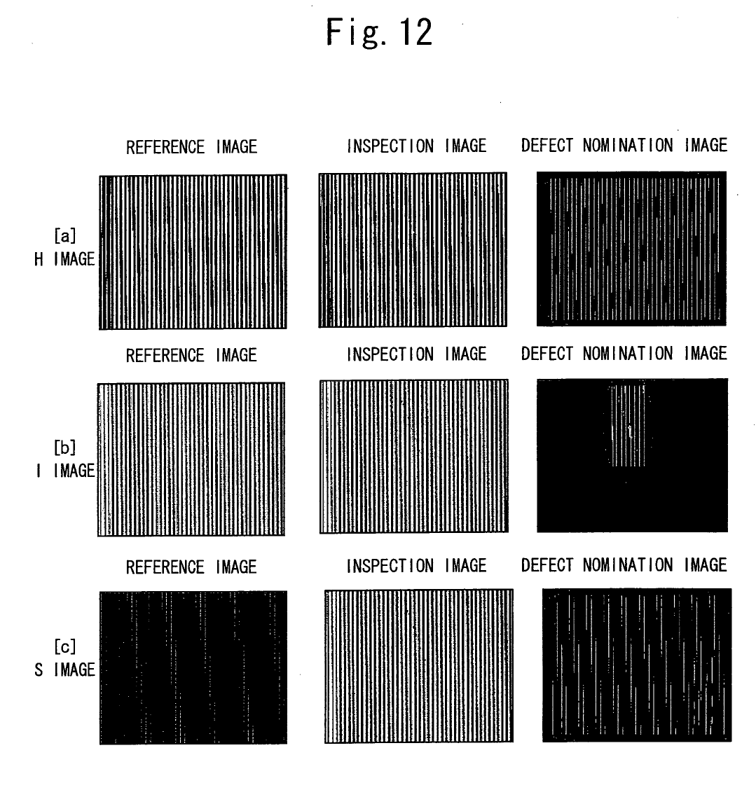

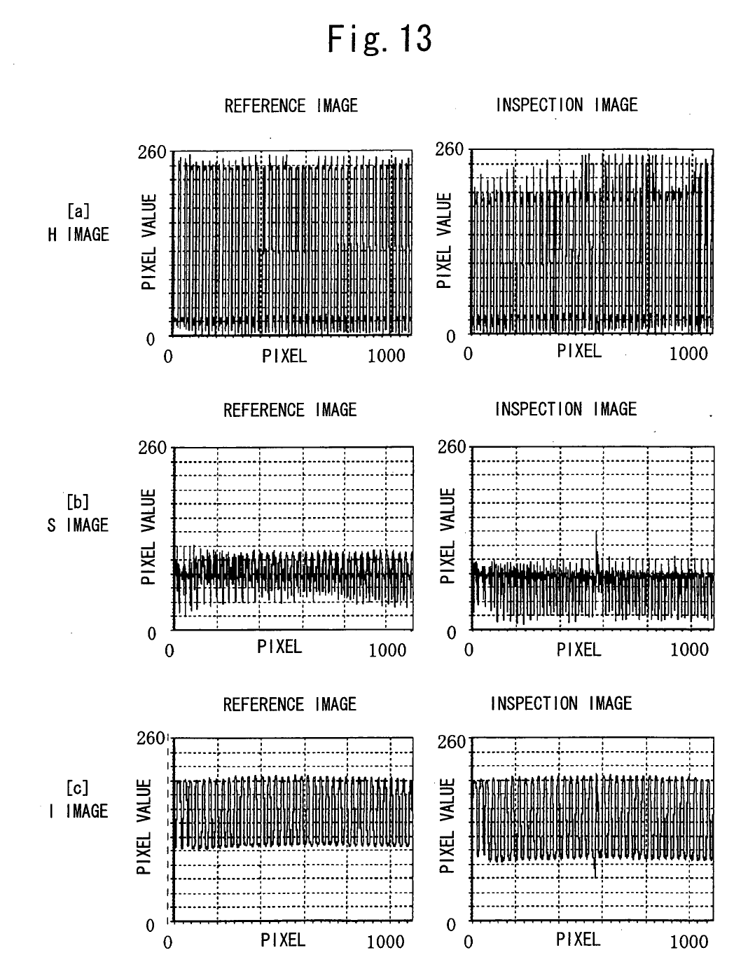

FIGS. 12[a] to 12[c] are H image/I image/S image generated by substituting the signal components RGB of the inspection image in the above-described expressions [1] to [3]. In the defect nomination images shown in FIGS. 12[a] to 12[c], an area of gray to white is an area in which a differential occurred (range of defect nomination). On the other hand, a dark area in the defect nomination images indicates an area where no differential occurred. FIGS. 13[a] to 13[c] illustrate signal waveforms of these H image/S image/I image.

Normally, a defect of scratch changes the degree of diffusion of reflected light, and generates a change of brightness/darkness in an inspection image. In addition, a regular pattern of the inspection target T also generates a change of brightness/darkness in an inspection image, but a scratch can be screened by comparison with a reference image. Therefore, a defect of scratch can be detected from the R image/G image/B image/I image as shown in FIG. 9 to FIG. 13. However, defects of scratch overlap in the R image, and hence the defects of scratch cannot be detected. Further, a change of the R image is reflected also on the I image, and thus the defect of film thickness partially overlaps with the defect of scratch. Therefore, a defect of scratch that overlaps with a film thickness defect can be detected from the G image and the B image.

In this embodiment, in analysis images (R image/G image/B image/H image/S image/I image) in which a defect nomination is detected, barycentric positions, vertical lengths, and horizontal lengths of defect nominations are obtained. These features of the defect nominations are compared among the analysis images.

Consequently, all the features of the defect nominations match in the G image and the B image. In this case, a common defect nomination can be determined as a defect by scratch.

Further, in the R image, the H image, and the S image, all the features of the defect nominations match. In this case, a common defect nomination can be determined as a defect by film thickness.

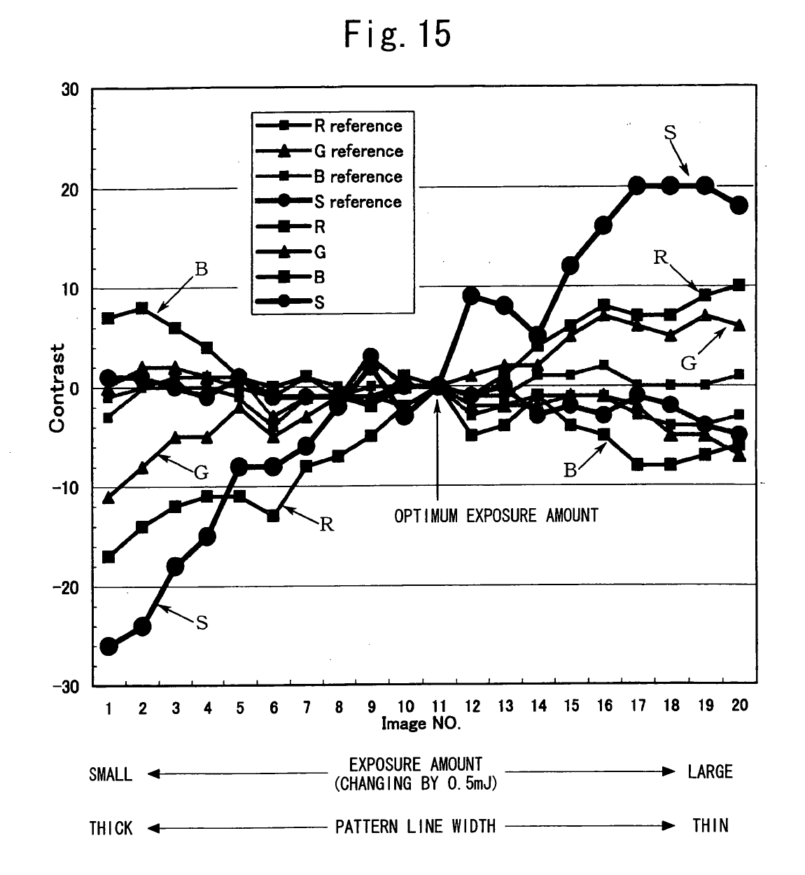

FIG. 15 is a chart showing a relationship between changes of pattern line widths and contrast changes of analysis images (R image/G image/B image/S image). By changing exposure amounts of the inspection samples T by 0.5 mJ, the pattern line widths of the inspection samples T are changed gradually. In these inspection samples T, No. 11 shown at the center of the horizontal axis is one formed by an optimum exposure amount. As shown in this FIG. 15, when an exposure amount (pattern line width) changes, the contrast of the S image changes most sensitively among the aforementioned analysis images. Therefore, by detecting a change of the S image, a defect of exposure amount and a defect of pattern line width can be detected with high sensitivity. Further, when a tolerance range (upper threshold value, lower threshold value, and the like) of contrast is set in advance, it is possible to determine whether an exposure amount or a pattern line width is good or bad.

As is clear from the above explanation, when differences are obtained by decomposing into color space information, a difference due to a slight difference of color is clearly shown by an image. This is not limited to the color spaces of HSI. The same applies to decomposing into color space information of HSV, HLS, or CMY. Further, for a defect nomination detected for each color space information, it is possible to divide or integrate defects overlapping at one position by obtaining the number of pixels in the vertical direction and the number of pixels in the horizontal direction of a pixel group of respective successive defect nomination pixels as well as a barycentric position of this area, and obtaining a logical product thereof.

(Additional Matters)

By repeating the above cycle for each inspection point, plural defects overlapping on an inspection target T (for example, wafer surface) can be detected reliably. Specifically, plural color space information obtained from one color image can be used as inspection information. It becomes possible to detect a defect that is visible to human eyes by an inspection apparatus, and also a defect that is difficult to be distinguished by human eyes can be detected using a difference of color space information as inspection information.

In the above examples, examples of decomposing into RGB, HSI color spaces as color space information are shown, but as described above, other color space conversion may be used, or filtering processing may be used for calculating two or more types of color components in units of pixel values and emphasizing them further.

The many features and advantages of the embodiments are apparent from the detailed specification and, thus, it is intended by the appended claims to cover all such features and advantages of the embodiments that fall within the true spirit and scope thereof. Further, since numerous modifications and changes will readily occur to those skilled in the art, it is not desired to limit the inventive embodiments to the exact construction and operation illustrated and described, and accordingly all suitable modifications and equivalents may be resorted to, falling within the scope thereof.

What is claims is:

1. A defect inspection apparatus, comprising:
an illumination unit illuminating an inspection target;
an image capturing unit obtaining a color image signal of said inspection target; and
a defect detection unit detecting a defect of said inspection target based on said color image signal obtained by said image capturing unit, wherein said defect detection unit comprises:
a component extracting unit obtaining a plurality of analysis images based on a plurality of signal components forming said color image signal;
a detection unit performing defect detection of said inspection target for each of said a plurality of analysis images, and detecting a defect nomination for each of said analysis images; and
a determination unit determining sameness of said defect nominations among said a plurality of analysis images to thereby determine whether a plurality of defects exist or not in a defect position of said inspection target.

2. The defect inspection apparatus according to claim 1, wherein said component extracting unit obtains at least two of said analysis images with at least two of said signal components being taken as pixel values, said signal components being selected from a group including three signal components forming said color image signal and three signal components of hue, saturation, and intensity obtained from said signal components.

3. The defect inspection apparatus according to claim 1, wherein:
said detection unit obtains a barycentric position, a vertical length, and a horizontal length of said defect nomination for each of said analysis images;
said determination unit determines that one defect exists in the defect position of said inspection target when all of said barycentric position, said vertical length, and said horizontal length for said defect nomination for each of said analysis images are evaluated to be equal; and
said determination unit determines that a plurality of defects exist in the defect position of said inspection target when any one of said barycentric position, said vertical length, and said horizontal length is evaluated to be different.

4. The defect inspection apparatus according to claim 1, wherein said detection unit detects said defect nomination based on a differential between an analysis image of a predetermined reference image and an analysis image of said inspection target.

5. The defect inspection apparatus according to claim 4, wherein said detection unit performs level correction on the analysis image of said inspection target in an entirety thereof so that a differential between entire images of the analysis image of said reference image and the analysis image of said inspection target becomes small.

6. The defect inspection apparatus according to claim 4, wherein said detection unit has threshold values set in advance respectively for said a plurality of analysis images, and detects said defect nomination by determining with said threshold values a differential between the analysis image of the reference image and the analysis image of said inspection target.

7. A defect inspection apparatus, comprising:
an illumination unit illuminating an inspection target having a film on a surface;
an image capturing unit obtaining a color image signal of said inspection target; and
a defect detection unit detecting a defect of said inspection target based on said color image signal obtained by said image capturing unit, wherein said defect detection unit comprises:
a component extracting unit obtaining a color information image having a pixel value corresponding to said color information based on at least one of saturation and hue of said color image signal; and
a detection unit performing defect detection of said inspection target based on said color information image, and detecting a defect nomination on thickness of said film.

8. The defect inspection apparatus according to claim 1, further comprising:
a microscope optical system forming an enlarged image of said inspection target; and
an imaging unit imaging said enlarged image and generating a color image signal, wherein
said image capturing unit of said defect inspection apparatus obtains said color image signal generated by said imaging unit.
